(19) United States
(12) Patent Application Publication
(10) Pub. No.: US 2025/0383574 A1
(43) Pub. Date: Dec. 18, 2025

(54) ELECTRONIC PAPER DISPLAY MODULE WITH IMPROVED ADHESION STRUCTURE

(71) Applicant: Young Fast Optoelectronics Co., Ltd., Taoyuan (TW)

(72) Inventors: CHIH-CHIANG PAI, Taoyuan (TW); MENG-KUEI LIN, Taoyuan (TW); LI-YEH YANG, Taoyuan (TW); SHU-MEI HSU, Taoyuan (TW)

(73) Assignee: Young Fast Optoelectronics Co., Ltd., Taoyuan, TW (TW)

(21) Appl. No.: 18/740,546

(22) Filed: Jun. 12, 2024

(51) Int. Cl. G02F 1/16753; G02F 1/167

(52) U.S. Cl. CPC G02F 1/16753; G02F 1/167

(57) ABSTRACT

An electronic paper display module with improved adhesion structure comprises: an electronic paper display module with an image display at a front structure thereof; a rectangular double sided tape layer at a front surface of the electronic paper display module; the rectangular double sided tape layer having a rectangular hollow inner space; a surface cover being on an upper side of the rectangular double sided tape layer; a peripheral edge of a lower surface of the surface cover being formed with a decorating edge frame; the decorating edge frame being a non-transparency or low transparency thin film layer; and a lower side of the decorating edge frame being adhered to an upper side of the rectangular double sided tape layer; a gluing layer installed at a lower bottom side of the electronic paper display module; and a supporting layer installed at a lower bottom side of the gluing layer.

### FIELD OF THE INVENTION

The present invention is related to, and in particular to an electronic paper display module, in particular to an electronic paper display module with improved adhesion structure.

### BACKGROUND OF THE INVENTION

Electronic paper displays have the advantages of having the properties of papers and lower power consumption. Recently, the electronic papers are widely applied to various portable electronic devices, however at this application, surfaces of the electronic paper display are easy to be collided, scratched, or destroyed by other ways. Therefore, in general, a cover lens is installed on a surface of the electronic paper display, in that, a sticky layer is coated on a surface of an electronic paper which is pressed for adhesion with the cover lens. A vacuum space is installed therein so that the reflection of light between the electronic paper and the cover lens are reduced so that the display is more transparent. Furthermore, the electronic paper is firmly combined with the cover lens so that the whole structure is enhanced. Although this technology of whole adhesion has many advantages, the yield ratio is low due to difficulty in adhesion. In the adhesion process, some defects generate, such as OCR leakage, non-uniform solidification of ultra light, and others. These defects cannot be reworked so as to induce the consumption of the electronic papers and cover lens, as a result the cost in labor works are increased. The costs of the electronic papers are high, if they are destroyed in adhesion process, the lose is high, especially, for large size electronic papers. All these increase the defects of the whole adhesion technology.

To improve the defect in the prior art, promote the yield ratios of the products, and reduce manufacturing costs, currently, a rectangular double sided tape layer is used to combine the edges of the electronic paper and the cover lens so as to reduce the cost in adhesion. An electronic paper display module is formed with a plurality of layers of plastic films, which are not preferred in anti-deformation. When only some parts of the areas (frames) between the electronic paper display module and the cover lens, the electronic paper display module is easy to deform or curled due to the variation of temperature or external forces applied thereto, as a result the structure is destroyed.

### SUMMARY OF THE INVENTION

Accordingly, the object of the present invention is to provide an electronic paper display module with improved adhesion structure, which has an improve mechanic strength, has the function of preventing deformation of the plate, and promotion the steadiness of the module.

To achieve above object, the present invention provides a n electronic paper display module with improved adhesion structure, comprising: an electronic paper display module with an image display at a front structure thereof; a rectangular double sided tape layer at a front surface of the electronic paper display module; the rectangular double sided tape layer having a rectangular hollow inner space; an edge of the rectangular hollow inner space of the rectangular double sided tape being exactly in contact with an outer edge of the image display; a surface cover being on an upper side of the rectangular double sided tape layer; a peripheral edge of a lower surface of the surface cover being formed with a decorating edge frame; the decorating edge frame being a non-transparency or low transparency thin film layer; and a lower side of the decorating edge frame being adhered to an upper side of the rectangular double sided tape layer; a gluing layer installed at a lower bottom side of the electronic paper display module; and a supporting layer installed at a lower bottom side of the gluing layer.

The material of the surface cover is selected from one of glass, poly methyl methacrylate (PMMA); polycarbonate (PC), Polyester (PET), Cyclic olefin copolymer (COC); and Cyclic olefin polymer (COP).

The material of the supporting layer is selected from one of glass plates, metal plates, and plastic plates.

The plastics layer is selected from one of polycarbonate (PC), Polyester, Polypropylene (PP), Acrylonitrile butadiene styrene resin, Polyamide (PA) resin and Polyethylene.

The gluing layer is an OCA gluing layer covering the back side of the electronic paper display module.

The gluing layer is a double sided tape form a plurality of gluing strips.

A light adjustment sheet is installed within the rectangular hollow inner space of the hollow centered rectangular double sided tape layer and is installed between the electronic paper display module and the surface cover.

The light adjustment sheet includes at least one haze surface.

### BRIEF DESCRIPTION OF THE DRAWINGS

FIG. 1 is an exploded perspective view showing the components in the first embodiment of embodiment.

FIG. 2 is a schematic cross section view about the assembly of the components of the first embodiment of the present invention.

FIG. 3 is an exploded a perspective view showing the exploded view of the components in second first embodiment of embodiment.

FIG. 4 is a schematic cross section view about the assembly of the components of the second embodiment of the present invention.

FIG. 5 is a partial enlarged view of the part C in FIG. 4, in that it is shown that the light adjustment sheet has a haze surface.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

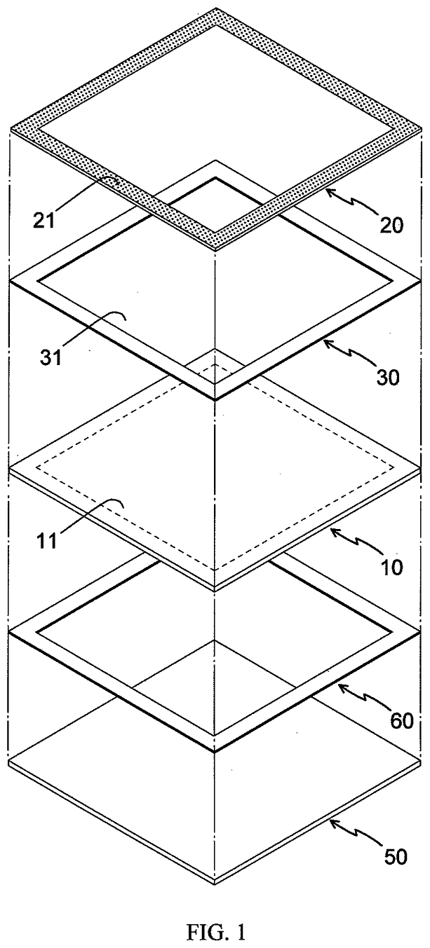

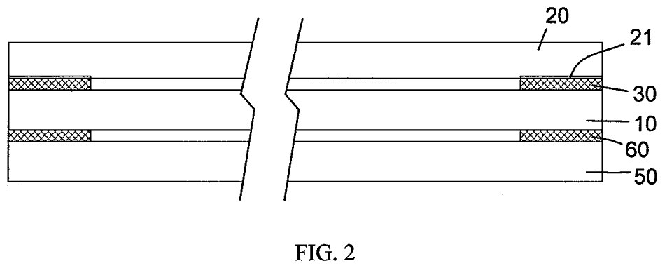

Referring to FIGS. 1 and 2, the electronic paper display module with improved adhesion structure of the present invention is illustrated as the following. The electronic paper display module with improved adhesion structure of the present invention includes the following elements.

An electronic paper display module 10 is a low power consumed flexible reflective display and has an image display 11 at a front face of the electronic paper display module 10 for displaying image frames by electrophoresis display (EPD) technology or cholesteric liquid crystal display (ChLCD) technology.

A surface cover 20, such as a glass, is a high light transparency thin plate with preferred mechanical strength, Besides, a peripheral edge of a lower surface of the surface cover 20 is formed with a decorating edge frame 21. The decorating edge frame 21 is a non-transparency or low transparency thin film layer which is made of non-conductive material, for example, the decorating edge frame 21 is made of a lower transparency thin film layer made of oil ink or light resistant material and coated or printed on a peripheral edge of a lower bottom side of the surface cover 20.

A hollow centered rectangular double sided tape layer 30 has a rectangular hollow inner space 31 which has a size approximately equal to the image display 11 of the electronic paper display module 10. The hollow centered rectangular double sided tape 30 is installed between the electronic paper display module 10 and the surface cover 20. An inner edge of the rectangular double sided tape layer 30 is exactly in contact with an outer edge of the injection cylinder 11 of the electronic paper display module 10. The rectangular double sided tape layer 30 serves to combine the electronic paper display module 10 and the surface cover 20.

The supporting layer 50, such as a glass plate, a metal plate, or a plastic plate, is a plate body with preferred mechanical strength.

A gluing layer 60 is installed at a lower back side of the electronic paper display module 10. In this embodiment, the gluing layer 60 is also a rectangular double sided tape, however, in other embodiment, the gluing layer 60 may have other forms, such as a double sided tape formed by a plurality of gluing strips, or an OCA gluing layer covering the back side of the electronic paper display module 10. The gluing layer 60 is installed between the electronic paper display module 10 and the supporting layer 50. Thereby, the electronic paper display module 10 are combined with the supporting layer 50 so that the mechanical strength of the electronic paper display module 10 is enhanced to prevent from deformation and promotion the steadiness of the whole structure.

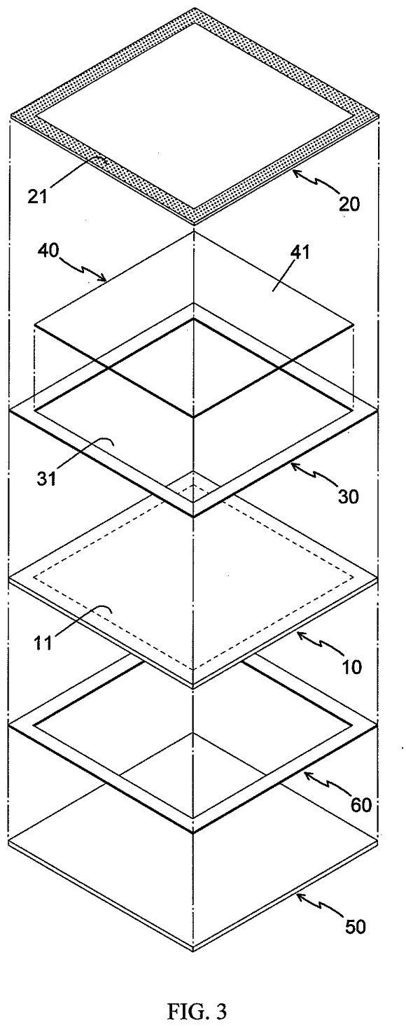

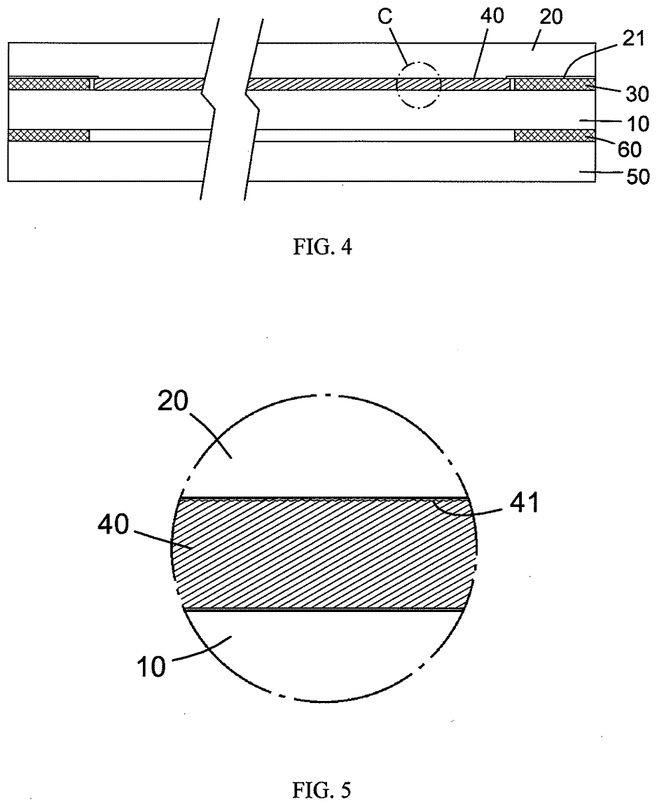

With reference to FIGS. 3 to 5, another preferred embodiment of the present invention is illustrated. The structure of this embodiment is identical to those illustrated in above mentioned embodiment, only the following differences exist, as said below. A light adjustment sheet 40 is installed within the rectangular hollow inner space 31 of the hollow centered rectangular double sided tape layer 30. The size of the light adjustment sheet 40 is equal to or smaller than that of the rectangular hollow inner space 31 of the rectangular double-sided tape 30, and a thickness of the light adjustment sheet 40 is substantially equal to that the rectangular double sided tape layer 30. The light adjustment sheet 40 includes a haze surface 41. The light adjustment sheet 40 is installed within the rectangular hollow inner space 31 of the rectangular double-sided tape 30 and between the electronic paper display module 10 and the surface cover 20 and is exactly on a front surface of the image display 11. Thereby, a haze surface on the light adjustment sheet 40 will generate diffuse reflection to light pass through the light adjustment sheet 40 so as to achieve the objects of anti-Newton ring and prevention of glare light so as to promote the quality of the image display 11.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An electronic paper display module with improved adhesion structure, comprising:
an electronic paper display module with an image display at a front structure thereof;
a rectangular double sided tape layer at a front surface of the electronic paper display module; the rectangular double sided tape layer having a rectangular hollow inner space; an edge of the rectangular hollow inner space of the rectangular double sided tape being exactly in contact with an outer edge of the image display;
a surface cover being on an upper side of the rectangular double sided tape layer; a peripheral edge of a lower surface of the surface cover being formed with a decorating edge frame; the decorating edge frame being a non-transparency or low transparency thin film layer; and a lower side of the decorating edge frame being adhered to an upper side of the rectangular double sided tape layer;
a gluing layer installed at a lower bottom side of the electronic paper display module; and
a supporting layer installed at a lower bottom side of the gluing layer.

2. The electronic paper display module with improved adhesion structure as claimed in claim 1, wherein material of the surface cover is selected from one of glass, poly methyl methacrylate (PMMA); polycarbonate (PC), Polyester (PET), Cyclic olefin copolymer (COC);
and Cyclic olefin polymer (COP).

3. The electronic paper display module with improved adhesion structure as claimed in claim 1, wherein material of the supporting layer is selected from one of glass plates, metal plates, and plastic plates.

4. The electronic paper display module with improved adhesion structure the electronic paper display module with improved adhesion structure as claimed in claim 3, wherein the plastic plates are selected from one of polycarbonate (PC), Polyester, Polypropylene (PP), Acrylonitrile butadiene styrene resin, Polyamide (PA) resin and Polyethylene.

5. The electronic paper display module with improved adhesion structure as claimed in claim 1, wherein the gluing layer is an OCA gluing layer covering the back side of the electronic paper display module.

6. The electronic paper display module with improved adhesion structure as claimed in claim 1, wherein the gluing layer is a double sided tape form a plurality of gluing strips.

7. The electronic paper display module with improved adhesion structure as claimed in claim 1, wherein a light adjustment sheet is installed within the rectangular hollow inner space of the hollow centered rectangular double sided tape layer and is installed between the electronic paper display module and the surface cover.

8. The electronic paper display module with improved adhesion structure as claimed in claim 7, wherein the light adjustment sheet includes at least one haze surface.
